(19) United States
(12) Patent Application Publication
(10) Pub. No.: US 2014/0313439 A1
(43) Pub. Date: Oct. 23, 2014

(54) DISPLAY DEVICE

(71) Applicant: Japan Display Inc., Tokyo (JP)

(72) Inventor: Shohei MATSUMOTO, Tokyo (JP)

(73) Assignee: Japan Display Inc., Tokyo (JP)

(21) Appl. No.: 14/254,970

(22) Filed: Apr. 17, 2014

(30) Foreign Application Priority Data
Apr. 19, 2013 (JP) 2013-088832

(51) Int. Cl. G06F 3/041

(52) U.S. Cl. CPC G06F 3/0412
USPC 349/12; 349/42

(57) ABSTRACT

A display device includes: a first substrate; a second substrate overlapping a portion of the first substrate; and a driver integrated circuit arranged in a non-overlapping area, which does not overlap with the second substrate, of the first substrate. The second substrate includes a side facing the driver integrated circuit, an integrated-circuit-opposed area on the second substrate formed along a line segment opposed to the driver integrated circuit in the side, and a terminal forming area being on the second substrate formed along the side and being different from the integrated-circuit-opposed area. A terminal of the second substrate is formed only in the terminal forming area.

### CROSS-REFERENCE TO RELATED APPLICATION

The present application claims priority from Japanese application JP2013-088832 filed on Apr. 19, 2013, the content of which is hereby incorporated by reference into this application.

### BACKGROUND OF THE INVENTION

1. Field of the Invention

The present invention relates to a display device, and particularly to a display device with a touch panel in which a touch panel and a display panel are formed integrally together.

2. Description of the Related Art

Touch panels configured to be overlaid on a display screen of an information communication terminal such as a computer have been widely used as input devices.

The touch panel is an input device that recognizes coordinates on a panel touched using a user's finger or the like and causes a processing device to perform processing. For the touch panel, a resistive film system that detects a change in the resistance value of a touched portion, an optical sensor system that detects a change in the light intensity of a portion blocked by a touch, an electrostatic capacitive coupling system that detects a change in capacitance, and the like have been known. The electrostatic capacitive coupling system has been widely used because, for example, it provides high panel transmittance and thus does not reduce display image quality and it provides high durability with no contact with other electrodes.

In recent years, due to the demand for reductions in the size and thickness of information communication terminals, a further reduction in the thickness of a liquid crystal display device with a touch panel has been required. JP 2012-068981 A discloses, in liquid crystal display devices of the IPS (In-Plane Switching) system in which both of pixel electrodes and common electrodes are arranged in a TFT (Thin Film Transistor) substrate, a liquid crystal display device with a touch panel whose thickness is further reduced by using common electrodes of the liquid crystal display device as drive electrodes of the touch panel.

### SUMMARY OF THE INVENTION

In a display device with a touch panel such as the liquid crystal display device with a touch panel, a counter substrate in which electrodes of the touch panel are wired is placed on a TFT substrate in which a transistor circuit that controls a display function is formed, and in many cases, a driver IC (Integrated Circuit) for display operation is placed on the TFT substrate on the same side as that where the counter substrate is placed. On the other hand, as to a flexible substrate (FPC (Flexible Printed Circuit)) for performing input and output to and from the outside, two flexible substrates are needed: one (first flexible substrate) is to be connected to the TFT substrate, and the other (second flexible substrate) is to be connected to the counter substrate for connecting to the electrodes of the touch panel. In such a case, when the second flexible substrate to be connected to the counter substrate (that is, a substrate in which the electrodes of the touch panel are formed) is arranged at a position interfering with the driver IC placed on the TFT substrate, there is a risk that the arrangement of the second flexible substrate is obstructive to a reduction in the size of the display device with a touch panel, especially to a reduction in the thickness thereof.

The invention has been made in view of the above circumstances, and it is an object of the invention to provide a display device and a display device with a touch panel whose sizes can be further reduced.

A display device according to an aspect of the invention includes: a first substrate including a thin film transistor; a second substrate overlapping a portion of the first substrate and including an electrode and a terminal connected to the electrode; and a driver integrated circuit arranged in a non-overlapping area, which does not overlap with the second substrate, of a surface of the first substrate facing the second substrate, wherein the second substrate includes a side facing the driver integrated circuit, an integrated-circuit-opposed area on the second substrate formed along a line segment opposed to the driver integrated circuit in the side, and a terminal forming area being on the second substrate formed along the side and being different from the integrated-circuit-opposed area, and the terminal of the second substrate is formed only in the terminal forming area.

In the display device according to the aspect of the invention, a flexible substrate may be connected to the terminal, and the flexible substrate may be arranged to cross over the side, the non-overlapping area, and an edge of the non-overlapping area opposite to the side, and overlap the terminal forming area but not overlap the integrated-circuit-opposed area and the driver integrated circuit as viewed in a plan view.

In the display device according to the aspect of the invention, the terminal forming area may be formed at at least two places so as to interpose the integrated-circuit-opposed area therebetween, the flexible substrate may include a recess so that the flexible substrate overlaps the terminal forming areas but does not overlap the integrated circuit, and the integrated circuit may be located so as to be interposed into the recess.

The display device according to the aspect of the invention may be a display device with a touch panel in which the electrode is used for touch detection.

In the display device according to the aspect of the invention, a cover plate covering the second substrate and the driver integrated circuit may be arranged on a surface of the second substrate opposite to the first substrate.

### BRIEF DESCRIPTION OF THE DRAWINGS

FIG. 1 shows a liquid crystal display device with a touch panel according to an embodiment of the invention.

FIG. 2 is a plan view showing the arrangement of electrodes used for touch detection of the touch panel in FIG. 1.

FIG. 3 schematically shows a cross section taken along the line III-III in FIG. 2.

FIG. 4 is an enlarged plan view showing a terminal connecting portion connected to a flexible substrate in a liquid crystal display panel with a touch panel.

FIG. 5 shows a cross section taken along the line V-V in FIG. 4.

FIG. 6 is an enlarged plan view showing a terminal connecting portion connected to a flexible substrate in a liquid crystal display panel with a touch panel of a comparative example of the embodiment.

FIG. 7 shows a cross section taken along the line VII-VII in FIG. 6.

FIG. 8 shows a first modified example of the embodiment.

FIG. 9 shows a second modified example of the embodiment.

### DETAILED DESCRIPTION OF THE INVENTION

Hereinafter, an embodiment of the invention will be described with reference to the drawings. In the drawings, the same or equivalent elements are denoted by the same reference numeral and sign, and the redundant description is omitted.

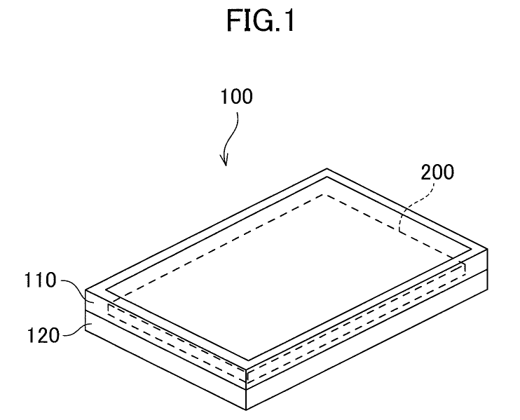

FIG. 1 schematically shows a liquid crystal display device with a touch panel 100 according to the embodiment of the invention. As shown in the drawing, the liquid crystal display device with a touch panel 100 includes a liquid crystal display panel with a touch panel 200, and an upper frame 101 and a lower frame 102 that fix the liquid crystal display panel with a touch panel 200 so as to interpose the liquid crystal display panel with a touch panel 200 therebetween.

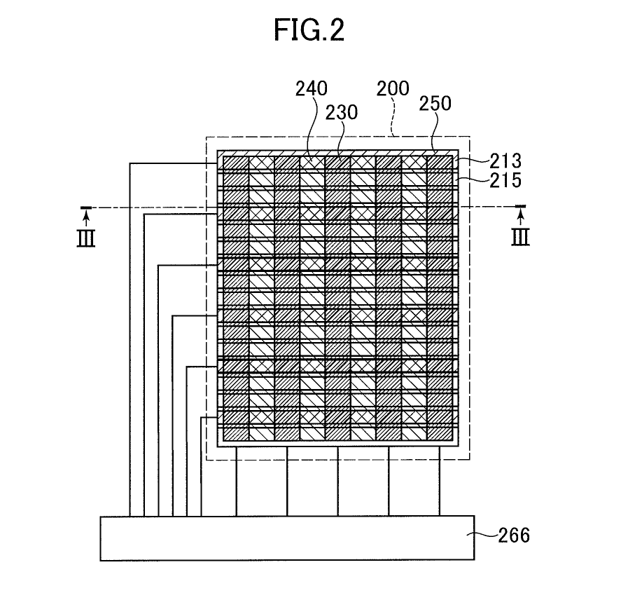

FIG. 2 is a plan view showing the arrangement of electrodes used for touch detection of the touch panel. A common electrode used for liquid crystal display has a strip shape extending in the short-side direction of a display area 250. The common electrode includes drive electrodes 213 to which a voltage is applied from a driver IC 260 (driver integrated circuit) as a touch panel control unit, and non-drive electrodes 215 that are electrodes other than the drive electrodes 213 and have a strip shape extending in the short-side direction of the display area. These electrodes are arranged so as to be laid all over the display area 250.

On the other hand, in a layer different from a layer in which the common electrode is arranged, a plurality of detection electrodes 230 and a plurality of dummy electrodes 240 are formed. The detection electrodes 230 extend in the long-side direction of the display area 250 and are arranged in parallel in the short-side direction of the display area 250. The dummy electrodes 240 are each arranged between the detection electrodes 230, extend in the same direction as the detection electrode 230, and are arranged in parallel. Signals detected by the detection electrodes 230 are input to the touch panel control unit 266 by each of the detection electrodes 230 to calculate touch coordinates. The dummy electrode 240 may be in an electrically floating state or may be grounded. In the case of the floating state, the dummy electrode 240 has an auxiliary capacitive function in touch detection. Each of the drive electrode 213, the non-drive electrode 215, the detection electrode 230, and the dummy electrode 240 is formed using a transparent conductive material such as ITO (Indium Tin Oxide). Moreover, each of the electrodes may be configured as a bundle of conductive wires in which a plurality of conductive wires are arranged at predetermined intervals.

Moreover, although not shown in the drawing, the touch panel control unit 266 includes a circuit that sequentially applies a drive pulse to the drive electrodes 213, a detector circuit that integrates signals detected by the detection electrodes 230, a register that stores parameters for controlling output timing or the like of the drive pulse, and an arithmetic processing unit (not shown) that computes, based on the output of the detector circuit, the presence or absence of a touch and a touch position on a display surface.

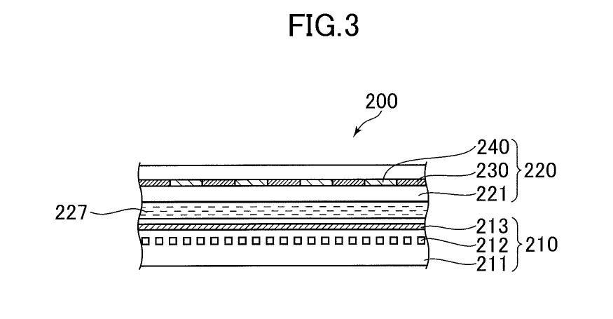

FIG. 3 schematically shows a cross section taken along the line in FIG. 2. As shown in the drawing, the liquid crystal display panel with a touch panel 200 includes a TFT substrate 210 (first substrate), a rectangular counter substrate 220 (second substrate), and a liquid crystal layer 227. In the TFT substrate 210, thin film transistors (TFTs) (not shown) are formed, and a circuit for controlling the orientation of liquid crystal by pixel arranged in a matrix is formed. The rectangular counter substrate 220 emits incident light, as lights at wavelengths of respective RGB colors, through color filters (not shown) pixel by pixel. The liquid crystal layer 227 is formed of a liquid crystal composition sealed between the substrates. As shown in FIG. 3, pixel electrodes 212, and the drive electrodes 213 and the non-drive electrodes 215 (refer to FIG. 2) that function as the common electrode in liquid crystal display are formed on a glass substrate 211 in the TFT substrate 210, while the detection electrodes 230 and the dummy electrodes 240 are formed on a glass substrate 221 in the counter substrate 220.

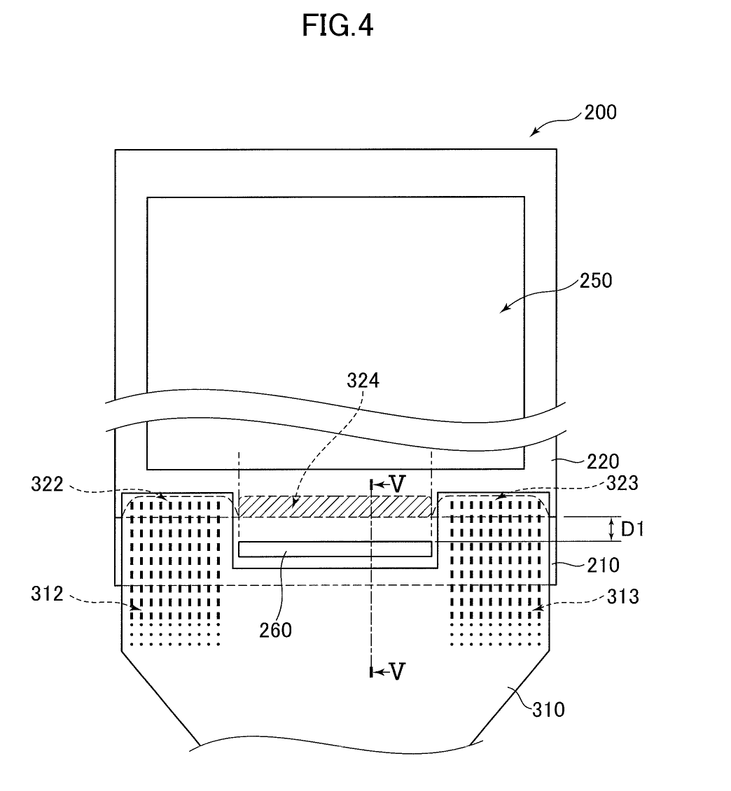

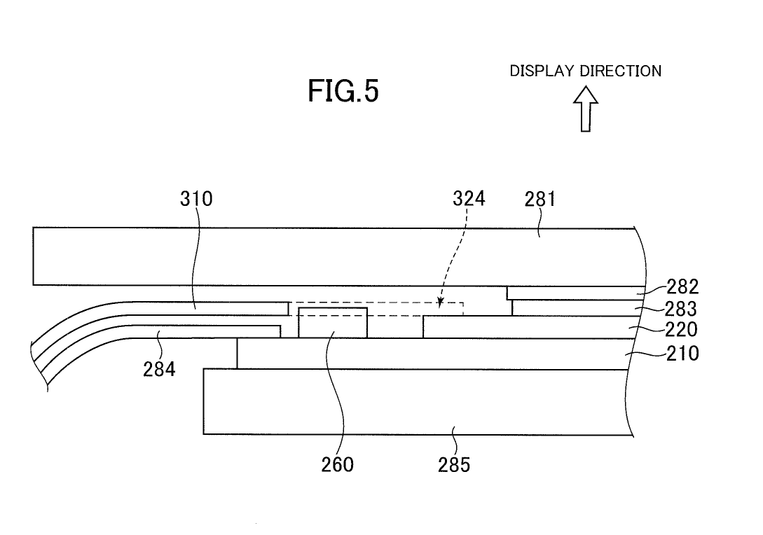

FIG. 4 is an enlarged plan view showing a second flexible substrate 310 connected to the counter substrate 220 and a terminal connecting portion formed in the counter substrate 220 in the liquid crystal display panel with a touch panel 200. FIG. 5 shows a cross section taken along the line V-V in FIG. 4. In FIG. 4, a polarizer 283, a UV (Ultra Violet) curable resin 282, a cover plate 281, and a first flexible substrate 284, which are shown in FIG. 5, are not illustrated. As shown in the drawings, the counter substrate 220 is attached so as not to overlap an area in which the driver IC (Integrated Circuit) 260 placed on the TFT substrate 210 is arranged and an area in which the first flexible substrate 284 is connected.

As shown in FIG. 4, a portion of the counter substrate 220 along a side thereof facing the driver IC 260 includes an integrated-circuit-opposed area 324, a first terminal forming area 322, and a second terminal forming area 323. The integrated-circuit-opposed area 324 is formed along a line segment opposed to the driver IC 260. The first terminal forming area 322 and the second terminal forming area 323 are areas that are formed so as to interpose the integrated-circuit-opposed area 324 therebetween and in which terminals of the counter substrate 220 connected to terminals of the second flexible substrate 310 are formed. The terminals of the counter substrate 220 are terminals that are connected to the detection electrodes 230 and output signals detected by the detection electrodes 230. The second flexible substrate 310 includes terminals that are connected using an ACF (Anisotropic Conductive Film) or the like to the terminals formed in the first terminal forming area 322 and the second terminal forming area 323, and wires 312 and wires 313 extending from the terminals of the second flexible substrate 310. The second flexible substrate 310 has a U-shape so that the second flexible substrate 310 does not cover the driver IC 260 and the integrated-circuit-opposed area 324.

As shown in FIG. 5, a backlight 285 is arranged on the TFT substrate 210 opposite to the counter substrate 220 side. The backlight 285 emits light toward a display direction, that is, toward the TFT substrate 210 side. On the display direction side of the counter substrate 220, the polarizer 283 is arranged. The cover plate 281 (protective plate or protective member) is provided on the polarizer 283 via the UV curable resin 282. When the cover plate 281 is formed of glass, the cover plate 281 is referred to also as a cover glass. The cover plate 281 is fixed also to the housing of a mobile information apparatus such as a mobile phone and acts, in some cases, also as a protective plate to be provided on the viewer side of a display screen of the mobile information apparatus. The first flexible substrate 284 is connected on a surface of the TFT substrate 210 on which the driver IC 260 is arranged, so that input signals to the driver IC 260 are connected. The height of the driver IC 260 from the TFT substrate 210 is higher than that of the counter substrate 220. In such a case, when the second flexible substrate 310 is arranged so as to cover the top of the driver IC 260, a wider space due to the location of the second flexible substrate 310 is needed between the driver IC 260 and the cover plate 281. As a result, there is a risk of an increase in the overall height of the liquid crystal display panel with a touch panel 200. In the embodiment, however, the shape of the second flexible substrate 310 has a recess arranged to avoid the driver IC 260 as shown in FIG. 4. Therefore, it is possible to form the liquid crystal display panel with a touch panel 200 while maintaining the thinness.

In the embodiment, the first flexible substrate 284 and the TFT substrate 210, and the second flexible substrate 310 and the counter substrate 220 are connected by means of the ACFs. However, the invention is not limited thereto. The substrates may be connected by other methods such as brazing using solder.

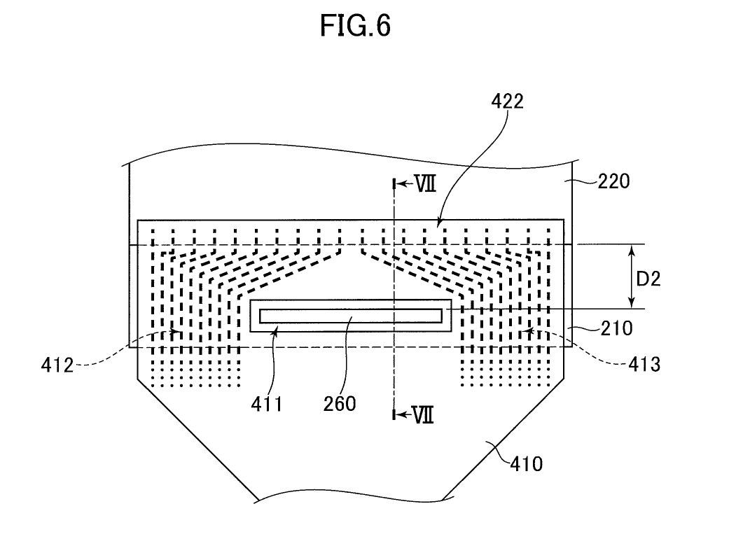

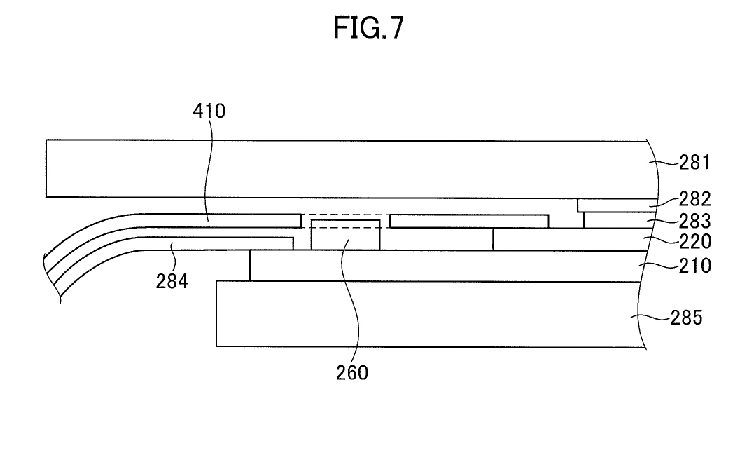

FIGS. 6 and 7 show a comparative example of the embodiment, corresponding respectively to FIGS. 4 and 5 of the embodiment in the same fields of view. Especially as shown in FIG. 6, the comparative example differs from the embodiment in that the integrated-circuit-opposed area 324, the first terminal forming area 322, and the second terminal forming area 323 are not formed, and that in an area of the counter substrate 220 along the side thereof facing the driver IC 260, terminals connected to a second flexible substrate 410 are formed at equal intervals. A hole 411 is formed in the second flexible substrate 410 only at the portion of the driver IC 260. The second flexible substrate 410 is not arranged on the top of the driver IC 260, so that the overall thinness of the liquid crystal display panel with a touch panel can be maintained.

When comparing FIG. 4 with FIG. 6, however, a distance between the driver IC 260 and the side of the counter substrate 220 facing the driver IC 260 is D1 in the embodiment in FIG. 4, whereas the distance is D2, which is larger than D1, in the comparative example in FIG. 6. Since the terminals are formed in an area of FIG. 6 corresponding to the integrated-circuit-opposed area 324 of FIG. 4, wires 412 and wires 413 need to be formed so as to avoid the top of the driver IC 260 and therefore the distance D2 is provided in the second flexible substrate 410. Because of the presence of this area, also the driver IC 260 needs to be arranged farther away from the edge of the counter substrate 220 on the TFT substrate 210. As a result, the size of the liquid crystal display panel with a touch panel 200 is increased.

Hence, by providing the integrated-circuit-opposed area 324, the first terminal forming area 322, and the second terminal forming area 323 as in the embodiment, the second flexible substrate 310 can be connected to the counter substrate 220 without increasing the size and thickness of the liquid crystal display panel with a touch panel 200. That is, it is possible to provide a display device with a touch panel that is further reduced in size.

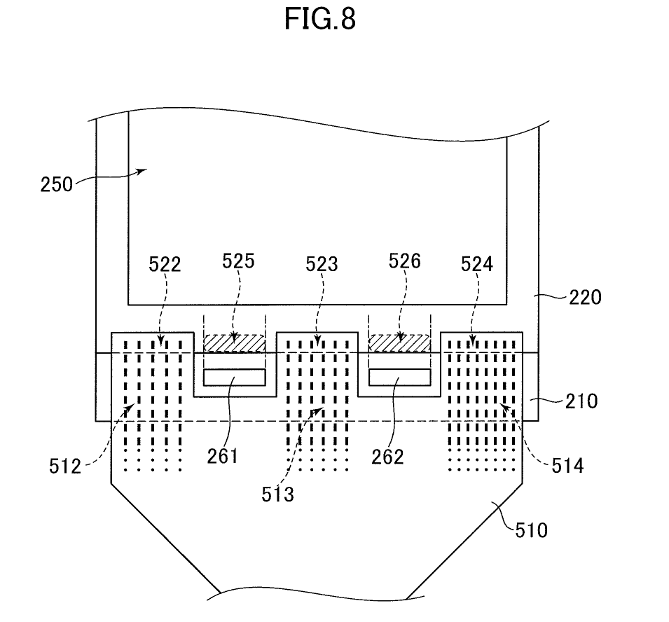

FIG. 8 shows a first modified example of the embodiment. The first modified example differs from the embodiment in that two driver ICs, a first driver IC 261 and a second driver IC 262, are placed on the TFT substrate 210. In this case, at portions of the counter substrate 220 along the side thereof facing the first driver IC 261 and the second driver IC 262, an integrated-circuit-opposed area 525 along a line segment opposed to the first driver IC 261 and an integrated-circuit-opposed area 526 along a line segment opposed to the second driver IC 262 are formed. In an area other than the integrated-circuit-opposed area 525 and the integrated-circuit-opposed area 526, a first terminal forming area 522, a second terminal forming area 523, and a third terminal forming area 524 are formed so as to interpose the integrated-circuit-opposed area 525 between the first and second terminal forming areas and the integrated-circuit-opposed area 526 between the second and third terminal forming areas. In the terminal forming areas, terminals connected to terminals of a second flexible substrate 510 are formed. In the interior of the second flexible substrate 510, wires 512, wires 513, and wires 514 are formed and connected to a control substrate (not shown). The wires 512 extend from terminals connected to terminal of the first terminal forming area 522. The wires 513 extend from terminals connected to terminal of the second terminal forming area 523. The wires 514 extend from terminals connected to terminal of the third terminal forming area 524. Even when the configuration of the first modified example is adopted, the same advantageous effects as those of the embodiment can be obtained. In the first modified example, the number of driver ICs is two. However, even when the number is three or more, the same advantageous effects can be obtained.

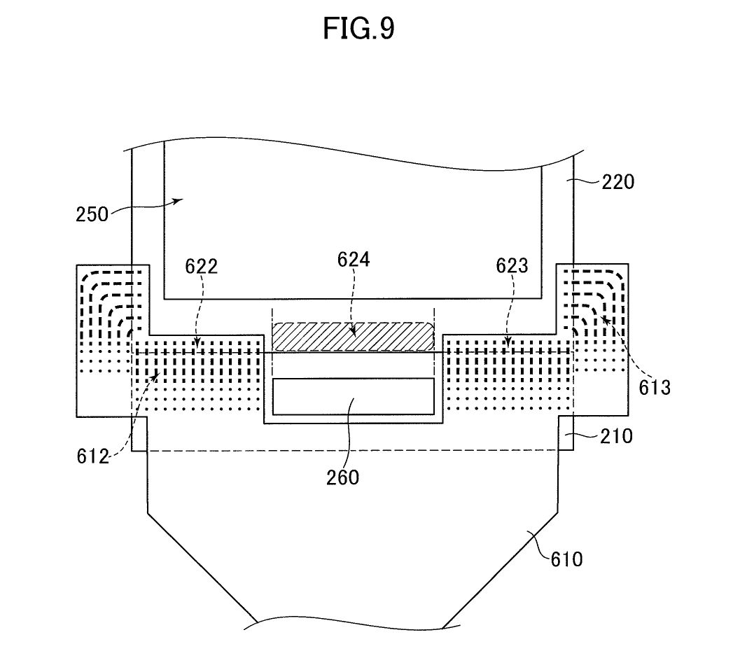

FIG. 9 shows a second modified example of the embodiment. The second modified example differs from the embodiment in that a first terminal forming area 622 and a second terminal forming area 623 formed so as to interpose an integrated-circuit-opposed area 624 of the counter substrate 220 therebetween are provided at portions along the side thereof facing the driver IC 260 and also expanded over areas along two sides extending in the vertical direction from the both ends of the above-described side. In this case, a plurality of terminals formed in each of the first terminal forming area 622 and the second terminal forming area 623 of the counter substrate 220 are formed along two sides forming a right angle. A flexible substrate 610 is formed in a shape to entirely cover the first terminal forming area 622 and the second terminal forming area 623 but not to cover the driver IC 260. In the interior of the flexible substrate 610, wires 612 and 613 are formed. The wires 612 and 613 extend from terminals connected by means of an ACF or the like with terminals formed in the first terminal forming area 622 and the second terminal forming area 623. Even when the configuration of the second modified example is adopted, the same advantageous effects as those of the embodiment can be obtained, and more signals can be input and output to and from the counter substrate 220.

In the embodiment, the electrodes formed in the counter substrate are detection electrodes whose potential changes according to the pulse applied to the drive electrode. However, the electrodes may be drive electrodes or other electrodes used for touch detection.

Moreover, in the embodiment, the display device used together with a touch panel is a liquid crystal display device. However, a display device that displays an image using a TFT substrate, such as an organic EL (Electro Luminescence) display device, can be used.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a first substrate including a thin film transistor;
a second substrate overlapping a portion of the first substrate and including an electrode and a terminal connected to the electrode; and
a driver integrated circuit arranged in a non-overlapping area, which does not overlap with the second substrate, of a surface of the first substrate, the surface facing the second substrate, wherein
the second substrate includes
a side facing the driver integrated circuit,
an integrated-circuit-opposed area on the second substrate formed along a line segment opposed to the driver integrated circuit, the line segment being a part of the side, and
a terminal forming area being on the second substrate, disposed along the side, and being different from the integrated-circuit-opposed area, and
the terminal of the second substrate is formed only in the terminal forming area.

2. The display device according to claim 1, wherein
a flexible substrate is connected to the terminal.

3. The display device according to claim 2, wherein
the flexible substrate is arranged to cross over the side, the non-overlapping area, and an edge of the non-overlapping area opposite to the side, and overlaps the terminal forming area but does not overlap the integrated-circuit-opposed area and the driver integrated circuit as viewed in a plan view.

4. The display device according to claim 2, wherein
the terminal forming area is formed at at least two places so as to interpose the integrated-circuit-opposed area therebetween,
the flexible substrate includes a recess so that the flexible substrate overlaps the terminal forming areas but does not overlap the integrated circuit, and
the integrated circuit is located so as to be interposed into the recess.

5. The display device according to claim 4, wherein
the flexible substrate includes a plurality of the recesses.

6. The display device according to claim 1, wherein
the electrode is used for touch detection.

7. The display device according to claim 1, wherein
the height of the driver integrated circuit from the first substrate is higher than that of the second substrate from the first substrate.

8. The display device according to claim 1, wherein
a cover plate covering the second substrate and the driver integrated circuit is arranged on a surface of the second substrate opposite to the first substrate.

9. A display device comprising:
a first substrate including a thin film transistor;
a second substrate overlapping a portion of the first substrate and including an electrode and a terminal connected to the electrode;
a driver integrated circuit arranged in a non-overlapping area, which does not overlap with the second substrate, of a surface of the first substrate, the surface facing the second substrate; and
a flexible substrate connected to the terminal, wherein
the second substrate includes
a side facing the driver integrated circuit,
an integrated-circuit-opposed area on the second substrate formed along a line segment opposed to the driver integrated circuit, the line segment being a part of the side, and
a terminal forming area being on the second substrate, disposed along the side, and being different from the integrated-circuit-opposed area,
the terminal of the second substrate is formed only in the terminal forming area, and
the flexible substrate overlaps the terminal forming area, and does not overlap the integrated-circuit-opposed area and the driver integrated circuit as viewed in a plan view.

10. The display device according to claim 9, wherein
the terminal forming area is formed at at least two places so as to interpose the integrated-circuit-opposed area therebetween.

11. The display device according to claim 10, wherein
the flexible substrate includes a recess so that the flexible substrate overlaps the terminal forming areas but does not overlap the integrated circuit, and
the integrated circuit is located so as to be interposed into the recess.

12. The display device according to claim 11, wherein
the flexible substrate includes a plurality of the recesses.

13. The display device according to claim 9, wherein
the electrode is used for touch detection.

14. The display device according to claim 9, wherein
the height of the driver integrated circuit from the first substrate is higher than that of the second substrate from the first substrate.

15. The display device according to claim 9, wherein
a cover plate covering the second substrate and the driver integrated circuit is arranged on a surface of the second substrate opposite to the first substrate.
